(19) United States
(12) Patent Application Publication
(10) Pub. No.: US 2009/0045202 A1
(43) Pub. Date: Feb. 19, 2009

(54) FLEXIBLE TANKS IN WHICH BULK LIQUIDS ARE TRANSPORTED

(76) Inventors: Terence Edward Denis Kelly, Western Cape (ZA); Mogamat Shafiek Ganief, Western Cape (ZA)

Correspondence Address: SCHWEGMAN, LUNDBERG & WOESSNER, P.A., P.O. BOX 2938, MINNEAPOLIS, MN, 55402, US

(21) Appl. No.: 12/034,484

(22) Filed: Feb. 20, 2008

(30) Foreign Application Priority Data
Mar. 14, 2007 (ZA) 20072141

(51) Int. Cl. B65D 90/02; B31B 1/00

(52) U.S. Cl. 220/565; 493/267

(57) ABSTRACT

A method of fabricating a flexible tank is disclosed which method comprises cutting away the corners of the upper layer (12) of a flattened flexible tube (10) and cutting away the corners of the lower layer (14) of the flattened flexible tube to provide, at each corner of each layer, a rectangular cut out bounded by first and second intersecting edges (24, 26/30, 32) with flaps (20, 22) between the cutouts. One of the flaps (20) of the upper layer (12) is welded to the underlying flap (22) of the lower layer along a transverse weld line (36). The upper flap and the weld line are then pulled in the direction which causes each flap (20, 22) to fold transversly whereby the upper flap (20) overlies both itself and the end part of the upper layer (12) and the lower flap (22) overlies both itself and the end part of the lower layer. Those parts of the layers which now lie outwardly of the end edges of the flaps are folded over on themselves along diagonal lines so that end zones thereof overlap end zones of the flaps (20, 22). The overlapping zones are welded together to close one end of the tank. The procedure is repeated to close the other end of the tank.

### RELATED APPLICATION

This application claims priority under 119 to South African Patent Application No. 2007/2141 filed Mar. 14, 2007, which application is incorporated herein by reference.

### FIELD OF THE INVENTION

THIS INVENTION relates to flexible tanks in which bulk liquids are transported.

### BACKGROUND TO THE INVENTION

A commercially used method of shipping a liquid in bulk is to pump the liquid into a flexible tank having walling of sheet synthetic plastics material. The tank is within a rigid outer container, usually an ISO shipping container, which confines the bag which would otherwise spread out and be overstressed when it was filled.

Tanks of this type are generally referred to in the industry as flexitanks and are usually manufactured from a tube of synthetic plastics material. Such material is supplied in the form of a reel and a length appropriate to that of the ISO container into which the flexitank is to fit is separated from the reel. A hole is cut in the tube to enable a filling/discharging structure to be fitted and if required a further hole is provided for an air bleed valve. The length of tubing is then sealed across both ends. This method of construction is sometimes referred to as being used to make a “pillow tank”.

The configuration of this type of flexible tank gives rise to two difficulties. First there are folds at the corners of the filled tank. These flex continually during transportation and so-called flex cracks can develop. Secondly, there are zones at the ends of the two transverse welds which are vulnerable to damage when the tank is being transported inside its ISO container. More specifically, the zones at the ends of the welds can rub on the inside of the ISO container. The transport conditions encountered, especially whilst the ISO container is onboard ship, can be such that the zones at the ends of the welds are worn through with consequent leakage of the contents of the tank.

The present invention seeks to provide a flexible tank which has a reduced prospect of the walling of the flexible tank being worn through as a result of rubbing action between it and the inside surface of the container within which it is transported.

### BRIEF DESCRIPTION OF THE INVENTION

According to one aspect of the present invention there is provided a length of flattened tubing from which a flexible tank can be manufactured, the corners of the upper layer of the flexible tubing and the corners of the lower layer of the flattened flexible tubing having been cut away to provide, at each corner of each layer, a generally rectangular cut out bounded by first and second intersecting edges.

The flaps left at each end of the layers of the flattened tubing are trazezoidal in shape. The flaps of one layer are wider where they join the remainder of the panel than they are along their free edges. The flaps of the other layer are narrower where they join the remainder of the layer than they are along their free edges. Said first edges can converge or diverge and constitute the edges of the flaps, these edges being at an angle of about 5° with respect to the longitudinal centre line of the respective layer.

Said second edges can be generally at right angles to the first edges and lie at an angle of about 95° with respect to said centre line where the second edges meet the first edges, the second edge are curved so that they meet the second edges at acute angles.

According to a further aspect of the present invention there is provided a method of fabricating a flexible tank which method comprises cutting away the corners of the upper layer of a flattened flexible tube and cutting away the corners of the lower layer of the flattened flexible tube to provide, at each corner of each layer, a rectangular cut out bounded by first and second intersecting edges with flaps between the cutouts, welding one of the flaps of the upper layer to the underlying flap of the lower layer along a transverse weld line, pulling the upper flap and the weld line in the direction which causes each flap to fold transversly whereby the upper flap overlies both itself and the end part of the upper layer and the lower flap overlies both itself and the end part of the lower layer, folding those parts of the layers which now lie outwardly of the end edges of the flaps over on themselves along diagonal lines so that end zones thereof overlap end zones of the flaps, and welding said overlapping zones together to close one end of the tank, and repeating the defined procedure to close the other end of the tank.

### BRIEF DESCRIPTION OF THE DRAWINGS

For a better understanding of the present invention, and to show how the same may be carried into effect, reference will now be made, by way of example, to the accompanying drawings in which:—

FIG. 1 is a top plan view of the top layer of a length of flattened tube;

FIG. 2 is an underneath plan view of the bottom layer of the length of flattened tube;

FIG. 3 is a diagrammatic representation of the tube split open and laid flat;

FIG. 4 illustrates one end of the length of tube with the top and bottom layer overlying one another;

FIG. 5 illustrates one end of the tube after folding; and

FIG. 6 illustrates the shape the tank adopts when filled and confined inside an outer container.

### DETAILED DESCRIPTION OF THE DRAWINGS

The flexitank according to the present invention is fabricated from a length of tubular liquid proof synthetic plastics material which is cut off a reel of the tubular material. The tubular material is flattened as it is wound onto the reel and hence the length cut off is also of flattened form. In the light of this, and for ease of description the length of material, designated 10 in the drawings, from which the tank is constructed, will be described as having a top layer 12 and a bottom layer 14.

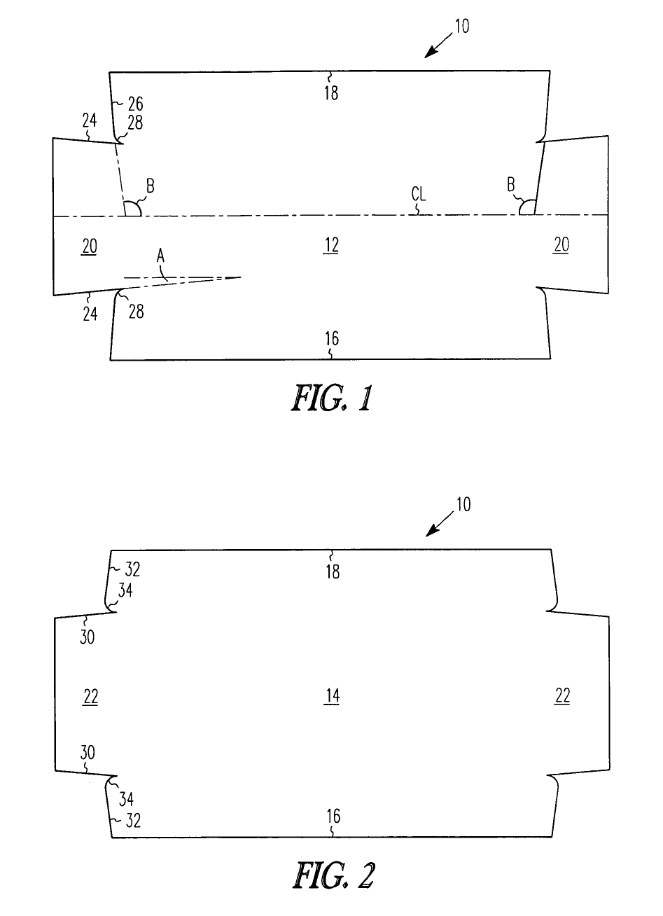

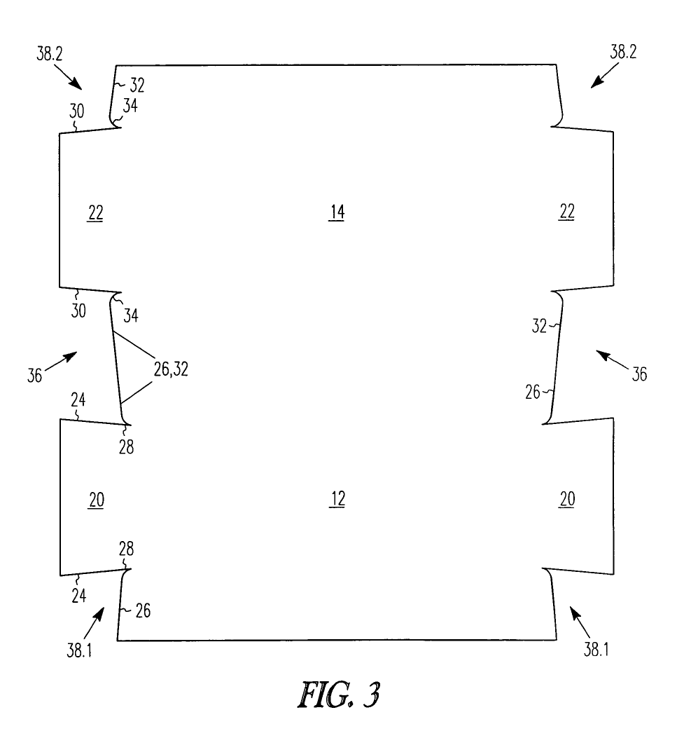

The top layer 12 (FIG. 1) is of generally rectangular form and is joined to the bottom layer 14 (FIG. 2) along two parallel, spaced apart fold lines 16 and 18.

The corners of the top layer 12 are cut away to form two flaps 20 and the corners of the bottom layer are cut away to form two flaps 22. There is a flap 20 at each end of the layer 12 and a flap 22 at each end of the layer 14.

Eight cuts are made in the top layer 12 to form the flaps 20. Four of the cuts are straight and leave edges 24 which are each at an angle A of 5° with respect to the longitudinal centre line CL of the layer 12. The pairs of edges 24 diverge from one another and hence each flap 20 has the shape of a trapezium. Each flap 20 is integral with the remainder of the layer 12 along the longer of its two parallel edges. The other four cuts leave edges 26 which are at an angle B of 95° with respect to the longitudinal centre line CL of the top layer.

The edges 26 are straight over most of their length but are curved at the end zones 28 where they join the edges 24 so that the edges 24, 26 are substantially parallel where they merge.

The bottom layer 14 (FIG. 2) is similar in configuration to the top layer 12. The edges which bound the flaps 22 are designated 30 and the edges equivalent to the edges 26 are designated 32. One difference between the top layer and the bottom layer is that in the top layer the pairs of edges 24 diverge whereas in the bottom layer the equivalent edges 30 converge. Another difference is that the edges 26 are at an acute angle to the edges 24 whereas the edges 32 are at an obtuse angle to the edges 30.

End zones 34 of the edges 32 are curved so that the edges 30, 32 are substantially parallel where they merge.

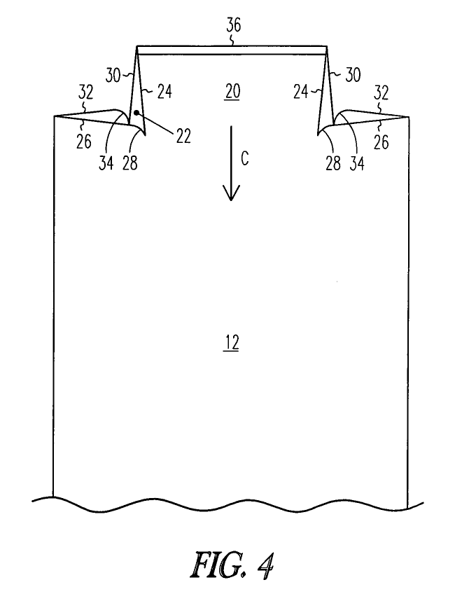

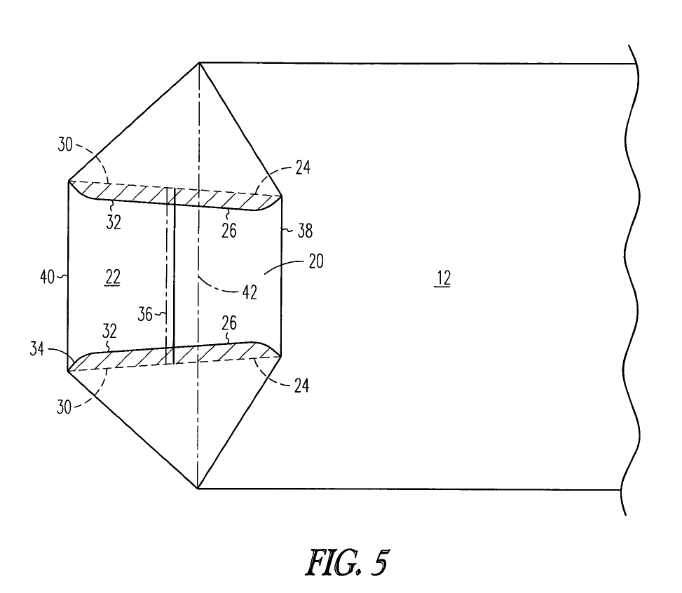

The relative configurations of the two layers is best seen in FIG. 4.

To achieve the desired configuration of the tank the total length of the pair of edges 24, 26 equals the total length of the pair of edges 30, 32. The edges 24 are not, however, of the same length as the edges 30 and the edges 26 are not the same length as the edges 32.

Once the cuts 24, 26, 30, 32 have been made in the length of tubing, the free edges of the flaps 20, 22 are welded together as shown at 36 in FIG. 4.

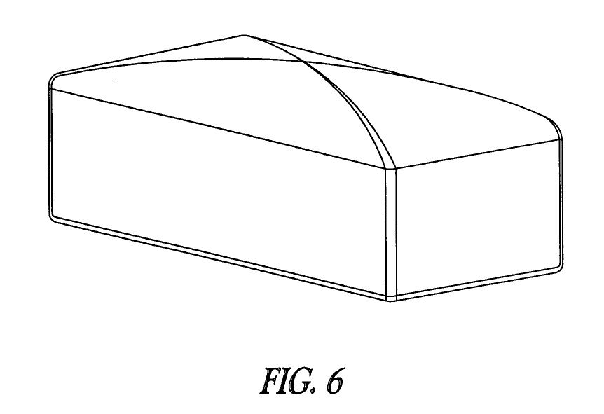

To form the end of the tank, the flap 20 is gripped along its diverging edges and pulled in the direction of the arrow C in FIG. 4. The weld line 36 is pulled in the same direction by the flap 20 and the flap 22 is consequently pulled in the same direction. The flaps are pulled until the weld line 36 is at the position shown in FIG. 5. The flap 20 is to the right of the weld line 36 and flap 22 is to the left. The fold designated 38 and 40 in FIG. 5 lie along the longer edges of the flaps 20,22.

The top layer 12 is as a consequence of this folded back on itself along the line designated 42 in FIG. 1. The parts of the layers which now lie outwardly of the flaps 20 and 22 are folded back and overlapped on themselves as shown in FIG. 5. Because of the differences in the configuration of the edges 24, 26 and 30, 32, the portions of the layers 12, 14 bounded by the edges 26, 32 overlap the portions of the layers bounded by the edges 24, 30. The overlapping portions are welded together in the cross hatched areas of FIG. 5 to close the container. This procedure is followed at both ends of the length of tubing.

1. A length of flattened tubing from which a flexible tank can be manufactured, the corners of the upper layer of the flexible tubing and the corners of the lower layer of the flattened flexible tubing having been cut away to provide, at each corner of each layer, a generally rectangular cut out bounded by first and second intersecting edges, there being flaps between the cut outs.

2. A length of flattened tubing as claimed in claim 1, wherein the flaps at each end of each of the layers of the flattened tubing are trazezoidal in shape.

3. A length of flattened tubing as claimed in claim 1 or 2, wherein the flaps of one layer are wider where they join the remainder of the panel than they are along their free edges.

4. A length of flattened tubing as claimed in claim 3, wherein the flaps of the other layer are narrower where they join the remainder of the layer than they are along their free edges.

5. A length of flattened tubing as claimed in any preceding claim, wherein said first edges of one layer converge and said first edges of the other layer diverge and constitute the edges of the flaps, these edges being at an angle of about 5° with respect to the longitudinal centre line of the respective layer.

6. A length of flattened tubing as claimed in claim 5, wherein said second edges are generally at right angles to the first edges and lie at an angle of about 95° with respect to said centre line.

7. A length of flattened tubing as claimed in claim 6, in which, where the second edges meet the first edges, the second edges are curved so that they converge with the first edges and are substantially parallel to them where they merge.

8. Method of fabricating a flexible tank which method comprises cutting away the corners of the upper layer of a flattened flexible tube and cutting away the corners of the lower layer of the flattened flexible tube to provide, at each corner of each layer, a rectangular cut out bounded by first and second intersecting edges with flaps between the cutouts, welding one of the flaps of the upper layer to the underlying flap of the lower layer along a transverse weld line, pulling the upper flap and the weld line in the direction which causes each flap to fold transversly whereby the upper flap overlies both itself and the end part of the upper layer and the lower flap overlies both itself and the end part of the lower layer, folding those parts of the layers which now lie outwardly of the end edges of the flaps over on themselves along diagonal lines so that end zones thereof overlap end zones of the flaps, and welding said overlapping zones together to close one end of the tank, and repeating the defined procedure to close the other end of the tank.

9. A flexible tank when fabricated in accordance with the method defined in claim 8.
